(19) United States
(12) Patent Application Publication
(10) Pub. No.: US 2004/0155977 A1
(43) Pub. Date: Aug. 12, 2004

(54) Digital camera that enters a sub-sampling mode for at least one auto function

(76) Inventors: Airell R. Clark II, Albany, OR (US); Dwight Poplin, Corvallis, OR (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/360,188

(22) Filed: Feb. 7, 2003

(51) Int. Cl. H04N 5/235

(52) U.S. Cl. 348/362

(57) ABSTRACT

A digital camera includes a shutter button, and an image sensor configured to enter a sub-sampling mode of operation for at least one auto function when the shutter button is pressed. The image sensor automatically enters a normal mode of operation after completion of the at least one auto function, and generates a digital image in the normal mode.

### THE FIELD OF THE INVENTION

The present invention generally relates to digital imaging systems, and more particularly to a digital camera that enters a sub-sampling mode for at least one auto function.

### BACKGROUND OF THE INVENTION

In existing digital cameras, there is a delay between the time when a user presses the button to take a picture and the time that a final image is actually taken. Between these times, the digital camera captures several test frames, analyzes the exposure and white balance of the test frames, and adjusts settings of the image sensor to provide proper exposure and white balance. This automatic determination of appropriate settings for exposure and white balance is referred to as auto exposure and auto white balance or AE/AWB.

AE/AWB in complimentary metal oxide semiconductor (CMOS) camera systems is typically accomplished through an iterative three-step process: (1) The image sensor captures a test frame; (2) the test frame is analyzed for proper exposure and white balance; and (3) if the exposure and/or white balance are not proper, the settings of the image sensor are adjusted to compensate.

In some digital cameras, this iterative process can take ten or more test frames. And the test frames used for AE/AWB in these cameras are full image frames. The time required to process these full frames can be detrimental to the performance that the user expects. For example, if the AE/AWB takes ten test frames to converge to the appropriate settings, and the camera is operating at fifteen frames per second, it will take at least two-thirds of a second to converge. If the user is trying to take a picture of some sort of moving object, the final captured image will be of what was in front of the camera two-thirds of a second after the user wanted to take the picture. This could easily result in the user being disappointed in the captured image.

CMOS cameras have a maximum frame rate that depends on many different variables, from integrated circuit (IC) process limitations (e.g., maximum clocking speed) to frame size (i.e., number of pixels per frame). The image sensors are designed to achieve their target frame rate at maximum frame size for minimum cost. This means that it is typically not possible to increase the frame rate by simply increasing the clock speed.

### SUMMARY OF THE INVENTION

One form of the present invention provides a digital camera including a shutter button, and an image sensor configured to enter a sub-sampling mode of operation for at least one auto function when the shutter button is pressed. The image sensor automatically enters a normal mode of operation after completion of the at least one auto function, and generates a digital image in the normal mode.

### BRIEF DESCRIPTION OF THE DRAWINGS

FIG. 1A is a diagram illustrating a simplified front view of a digital camera according to one embodiment of the present invention.

FIG. 1B is a diagram illustrating a simplified rear view of the digital camera shown in FIG. 1A according to one embodiment of the present invention.

FIG. 2 is a block diagram illustrating major components of the digital camera shown in FIGS. 1A and 1B according to one embodiment of the present invention.

FIG. 3 is a block diagram illustrating major components of the image sensor shown in FIG. 2 according to one embodiment of the present invention.

FIG. 4 is a flow diagram illustrating a method for automatically adjusting sensor settings in the digital camera shown in FIGS. 1A and 1B for proper exposure and white balance according to one embodiment of the present invention.

### DESCRIPTION OF THE PREFERRED EMBODIMENTS

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

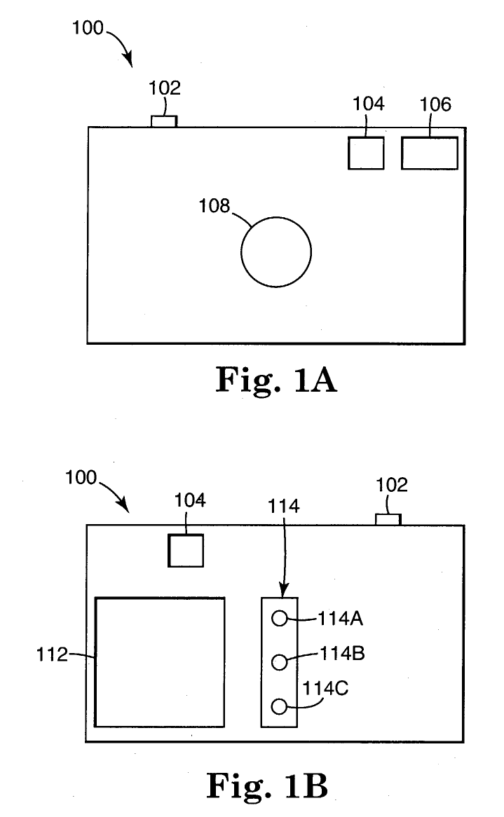

FIG. 1A is a diagram illustrating a simplified front view of a digital camera 100 according to one embodiment of the present invention. FIG. 1B is a diagram illustrating a simplified rear view of the digital camera 100 shown in FIG. 1A. As shown in FIGS. 1A and 1B, camera 100 includes shutter button 102, optical viewfinder 104, flash 106, lens 108, liquid crystal display (LCD) 112, and user input device 114. User input device 114 includes buttons 114A-114C. User input device 114 allows a user to enter data and select various camera options.

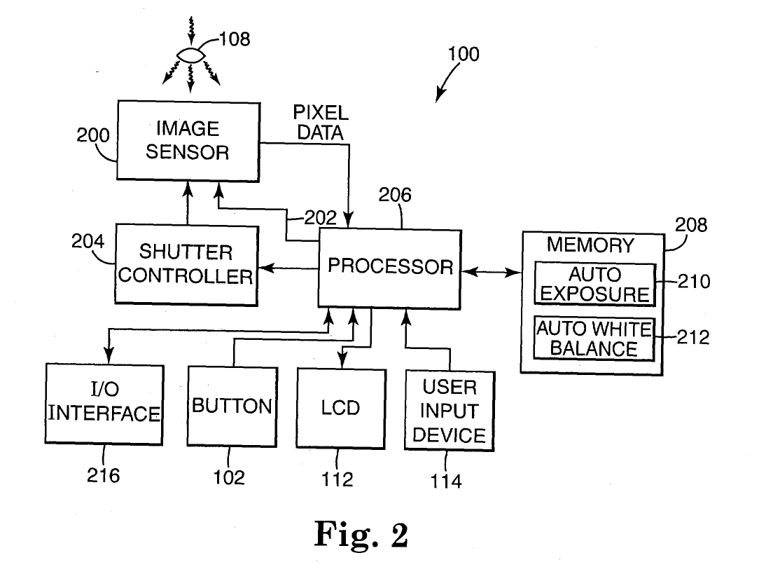

In operation, a user looks through optical viewfinder 104 or at LCD 112 and positions camera 100 to capture a desired image. When camera 100 is in position, the user presses shutter button 102 to capture the desired image. An optical image is focused by lens 108 onto image sensor 200 (shown in FIG. 2), which generates digital pixel data that is representative of the optical image. Captured images are displayed on display 112. Flash 106 is used to illuminate an area to capture images in low-light conditions. In one embodiment, when a user presses shutter button 102 to capture a desired image, digital camera 100 enters a sub-sampling mode and performs auto functions, such as auto exposure and auto white balance functions, as described in further detail below. In one embodiment, auto functions are algorithms that extract one or more features from an image, analyze the features using one or more classifiers, and adjust one or more parameters of the image sensor 200 or imaging processing in accordance with the analysis results.

FIG. 2 is a block diagram illustrating major components of digital camera 100 according to one embodiment of the present invention. Camera 100 includes lens 108, image sensor 200, shutter controller 204, processor 206, memory 208, input/output (I/O) interface 216, shutter button 102, LCD 112, and user input device 114. In one embodiment, memory 208 includes some type of random access memory (RAM) and non-volatile memory, but can include any known type of memory storage. An auto exposure algorithm 210 and an auto white balance algorithm 212 are stored in memory 208. In one form of the invention, algorithms 210 and 212 are conventional algorithms that are known to those of ordinary skill in the art. In one embodiment, image sensor 200 is configured to operate in a normal mode of operation and at least one sub-sampling mode of operation. The mode of operation of sensor 200 is programmable by processor 206 via communication link 202.

In operation according to one embodiment, when processor 206 detects that a user has pressed shutter button 102, processor 206 programs image sensor 200 to enter a sub-sampling mode. In the sub-sampling mode according to one embodiment, image sensor 200 operates at a faster frame rate than in the normal mode. After entering the sub-sampling mode, processor 206 performs an iterative auto exposure and auto white balance process. During this process, processor 206 and shutter controller 204 cause image sensor 200 to capture a test frame. Image sensor 200 outputs sub-sampled pixel data from the test frame to processor 206. Processor 206 analyzes image features of the sub-sampled pixel data using auto exposure algorithm 210 and auto white balance algorithm 212, and determines if adjustments to the settings of sensor 200 should be made. If the image parameters (e.g., exposure and/or white balance) are not proper (e.g., they do not meet given target values or a threshold level of goodness), processor 206 adjusts settings of sensor 200, causes image sensor 200 to capture another test frame, and repeats this process until the exposure and white balance have converged to the target values.

By sampling only a portion of each test frame, the sensor settings for providing proper exposure and white balance can be determined in a significantly reduced time. In one embodiment, the sub-sampling is done in a manner that provides a reasonably accurate sampling of the entire image.

In one form of the invention, once the exposure and white balance have converged, processor 206 programs image sensor 200 to return to the normal mode of operation, and a final frame is captured in the normal mode. The pixel data for the final frame is stored in memory 208, and may also be displayed on LCD 112.

I/O interface 216 is configured to be coupled to a computer or other appropriate electronic device (e.g., a personal digital assistant), for transferring information between camera 100 and the computer, including downloading captured images from camera 100 to the computer.

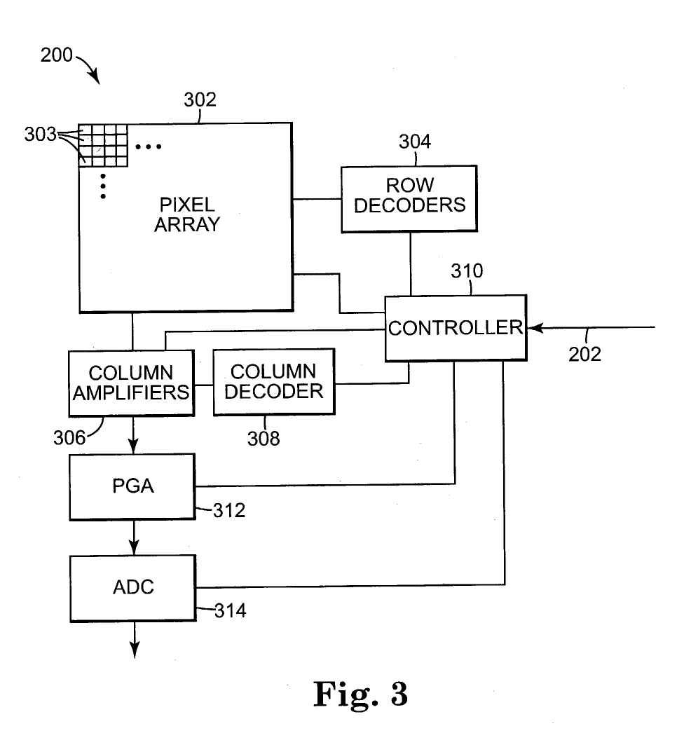

FIG. 3 is a block diagram illustrating major components of the image sensor 200 shown in FIG. 2 according to one embodiment of the present invention. In one embodiment, image sensor 200 is a complimentary metal oxide semiconductor (CMOS) image sensor. CMOS image sensors sense light by converting incident light (photons) into electronic charge (electrons) by a photo-conversion process. Color CMOS image sensors are typically made by coating each individual pixel with a filter color (e.g. red, green, and blue). CMOS image sensors typically include a photo sensor (e.g., photo diode) and several CMOS transistors for each pixel. In one embodiment, image sensor 200 is implemented with a single integrated circuit that provides integrated analog-to-digital conversion and timing control.

Image sensor 200 includes pixel array 302, row decoders 304, column amplifiers 306, column decoder 308, controller 310, programmable gain amplifier (PGA) 312, and analog-to-digital converter (ADC) 314. Pixel array 302 includes a plurality of pixel circuits (pixels) 303, with each pixel circuit 303 providing one pixel of image information. The pixel circuits 303 in pixel array 302 are organized into a plurality of rows and a plurality of columns (e.g., 480×640). In one form of the invention, each pixel circuit 303 includes a plurality of Metal-Oxide-Semiconductor Field Effect Transistors (MOSFETS) and a photodiode (not shown) configured in a conventional manner known to those of ordinary skill in the art.

Controller 310 is coupled to pixel array 302, row decoders 304, column amplifiers 306, column decoder 308, programmable gain amplifier 312, and analog-to-digital converter 314. Controller 310 generates control signals for controlling the operation of sensor 200, including signals to initiate, maintain, and stop image capture processes.

In one form of the invention, column amplifiers 306 include one column amplifier for each column of pixels 303 in array 302, and pixel information from pixel array 302 is sampled in rows. The sampling time for each row of pixels is referred to as a row sample interval. A row of pixels 303 in pixel array 302 is selected by row decoders 304.

The sampling of pixel information according to one embodiment is divided into three phases: (1) an integration phase; (2) a sample reset phase; and (3) an integration reset phase. During the integration phase, pixel circuits 303 integrate the amount of light directed onto their photodiodes, and output integrated voltages, Vs. Column amplifiers 306 act as an analog buffer that samples and holds the outputs of a selected row of pixels 303. At the end of the integration phase, column amplifiers 306 sample the integrated signal levels, Vs, from a selected row of pixels 303. The second phase of pixel sampling is the sample reset phase, where a selected row of pixels 303 is reset. At the end of the sample reset phase, column amplifiers 306 sample the reset level, Vr, output by the selected row of pixels 303.

In one embodiment, the image signal generated by each pixel circuit 303 is the difference between the sampled reset voltage level, Vr, and the sampled integration voltage level, Vs, obtained after the integration period. At the end of a row sample interval, the difference between the reset signal levels, Vr, and integrated signal levels, Vs, is held on the outputs of column amplifiers 306, referenced to a common mode reference level. During a column processing interval, column amplifiers 306 are sequentially selected by column decoder 308 to output the corresponding held level.

During the integration reset phase, each pixel circuit 303 is reset to ensure that the pixel circuits 303 start from a common voltage independent of the integration level of a previously captured frame.

Programmable gain amplifier 312 amplifies the analog signals output by column amplifiers 306, and outputs the amplified signals to analog-to-digital converter 314. Controller 310 controls the gain of amplifier 312. In one embodiment, the gain for red, green, and blue pixels can be separately adjusted by controller 310. Analog-to-digital converter 314 digitizes the analog signals received from amplifier 312, and outputs digital pixel data.

In one embodiment, sensor 200 supports a normal mode and various sub-sampling modes of operation, which are programmable from processor 206 via communication link 202. In one embodiment of the normal mode, all of the pixels in the array 302 are sampled. In one embodiment of the sub-sampling modes, the number of pixels in the array 302 that are sampled is reduced, while the field of view is maintained. In one embodiment, enabling sub-sampling increases the frame rate of sensor 200. For example, in a two-to-one sub-sampling mode (e.g., sample two pixels, skip two pixels, sample two pixels, etc.), the amount of image data that is processed is reduced by a factor of four when sub-sampling in both the horizontal and vertical directions, but an accurate sample of the image is obtained for auto exposure and auto white balance. This results in almost a factor of four reduction in the amount of time per iteration of the auto exposure and auto white balance algorithms 210 and 212. Thus, using the example described above in the Background of the Invention section, instead of two thirds of a second to obtain the ten test frames to reach exposure and white balance convergence, in one embodiment of the present invention, convergence can be achieved in one sixth of a second, with almost no impact on accuracy.

In a four-to-one sub-sampling mode (e.g., sample two pixels, skip six pixels, sample two pixels, etc.), the amount of image data that is processed is reduced by a factor of sixteen when sub-sampling in both the horizontal and vertical directions. This results in almost a factor of sixteen reduction in the amount of time per iteration of the auto exposure and auto white balance algorithms 210 and 212, which reduces convergence time from two thirds of a second to about one twenty-fourth of a second.

As mentioned above, during the auto exposure and auto white balance iterative process, parameters or settings of sensor 200 are modified. In one embodiment, these settings include the integration time of sensor 200 and the analog gain of amplifier 312. The integration time of sensor 200 is programmable by shutter controller 204 (shown in FIG. 2). The gain of amplifier 312 can be programmed by processor 206 via communication link 202. To modify the exposure of frames, the integration time and/or the analog gain is adjusted. To modify the white balance of frames, the gain provided by amplifier 312 is separately adjusted for each set of pixels (i.e., red, green, and blue).

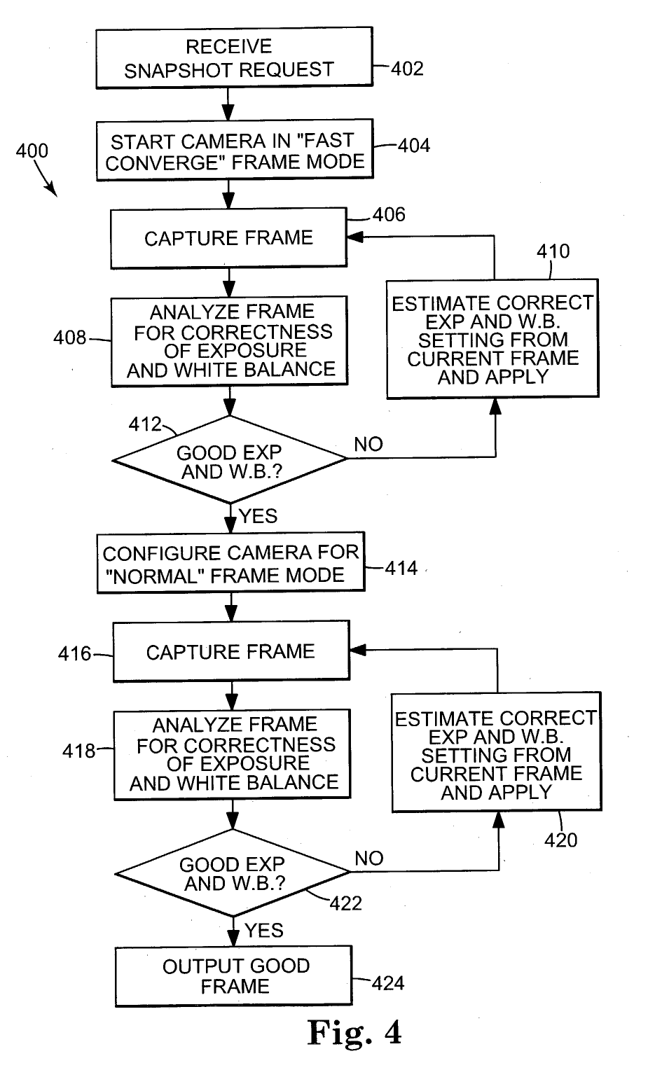

FIG. 4 is a flow diagram illustrating a method 400 for automatically adjusting sensor settings in digital camera 100 for proper exposure and white balance according to one embodiment of the present invention. In step 402, processor 206 receives a snapshot request. In one embodiment, a user initiates a snapshot request by pressing shutter button 102, which is detected by processor 206. In step 404, camera 100 starts a “fast converge” frame mode. In one form of the invention, the fast converge frame mode is started by processor 206, which programs image sensor 200 to enter a sub-sampling mode. In one embodiment, the frame rate of the image sensor 200 in the sub-sampling mode is faster than the frame rate in the normal mode.

In step 406, a frame is captured by sensor 200. In one embodiment, processor 206 and shutter controller 204 cause image sensor 200 to capture the frame, and image sensor 200 generates and outputs sub-sampled pixel data (sub-sampled frame) to processor 206. In step 408, processor 206 analyzes the exposure and white balance of the sub-sampled frame. In step 412, processor 206 determines whether the exposure (Exp) and white balance (W.B.) of the sub-sampled frame are good (i.e., satisfy a target value or a threshold level of goodness). If it is determined in step 412 that the exposure and white balance of the sub-sampled frame are not satisfactory, the method moves to step 410. In step 410, processor 206 estimates correct exposure and white balance settings from the current sub-sampled frame, and applies these settings to sensor 200. The method then returns to step 406 to capture another frame. Several sub-sampled frames may be generated and analyzed during steps 406-412 before the exposure and white balance converge to acceptable values. However, the higher frame rate in the sub-sampling mode provides a faster convergence than obtained by previous digital cameras.

If it is determined in step 412 that the exposure and white balance of the sub-sampled frame are good, the method moves to step 414. In step 414, camera 100 exits the sub-sampling mode and returns to a normal frame mode. In one form of the invention, processor 206 programs image sensor 200 to enter the normal mode.

In step 416, a full frame is captured by sensor 200. In one embodiment, processor 206 and shutter controller 204 cause image sensor 200 to capture the frame, and image sensor 200 generates and outputs a full frame of pixel data to processor 206. In step 418, processor 206 analyzes the exposure and white balance of the frame. In step 422, processor 206 determines whether the exposure (Exp) and white balance (W.B.) of the frame are good. If it is determined in step 422 that the exposure and white balance of the frame are not satisfactory, the method moves to step 420. In step 420, processor 206 estimates correct exposure and white balance settings from the current frame, and applies these settings to sensor 200. The method then returns to step 416 to capture another frame.

If it is determined in step 422 that the exposure and white balance of the frame are good, the method moves to step 424. In step 424, the image frame is output to LCD 112, where it is displayed to the user. For most cases, the first frame captured in step 416 will have good exposure and white balance, and step 420 will not be performed. However, for rapidly changing scenes, more than one full frame may be captured in the normal mode.

It will be understood by a person of ordinary skill in the art that functions performed by camera 100 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

One form of the present invention provides a method for increasing the frame rate in a digital imaging system, such as a digital camera, to shorten the time to convergence of auto function algorithms, such as auto exposure and auto white balance (AE/AWB) algorithms, without substantially impacting AE/AWB accuracy. In one embodiment, because of the fast AE/AWB convergence, a final image is captured and output in a much shorter time than previously achieved. In addition to AE/AWB, it will be understood by persons of ordinary skill in the art that the techniques disclosed herein are also applicable to other auto functions, such as automatic flicker detection and automatic black level.

Although one embodiment of the present invention is directed to using sub-sampling to increase the frame rate for AE/AWB, in other embodiments, other techniques that trade off image quality for faster frame rates can be used to reduce the time to AE/AWB convergence, preferably without substantially affecting the AE/AWB accuracy. Like sub-sampling, these other techniques may have a negative impact on image quality. However, for the frames that are used to determine exposure and white balance, image quality is not an issue. In fact, these frames are typically discarded once the auto exposure and auto white balance analyses have been performed.

One form of the present invention uses “windowing” to provide an increased frame rate for AE/AWB. Windowing is a feature of some CMOS image sensors that allows a window to be programmed into the sensor, so that only the pixels in that window are used. For example, even though a sensor may have 640 by 480 pixels, the sensor can be programmed to only use a subset of these pixels, such as the 320 by 240 pixels in the middle of the array, or some other window may be programmed. In one embodiment, windowing is used as an alternative to sub-sampling to provide an increased frame rate for AE/AWB. In another embodiment, windowing is used in addition to sub-sampling to provide an increased frame rate for AE/AWB.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A digital camera comprising:
a shutter button; and
an image sensor configured to enter a sub-sampling mode of operation for at least one auto function when the shutter button is pressed, automatically enter a normal mode of operation after completion of the at least one auto function, and generate a digital image in the normal mode.

2. The digital camera of claim 1, wherein the at least one auto function includes at least one of auto exposure, auto white balance, automatic flicker detection, and automatic black level.

3. The digital camera of claim 1, wherein the image sensor is configured to capture images at a first frame rate in the sub-sampling mode of operation, and capture images at a second frame rate in the normal mode of operation, and wherein the first frame rate is faster than the second frame rate.

4. The digital camera of claim 1, and further comprising:
a controller for sensing when the shutter button is pressed, and causing the image sensor to enter the sub-sampling mode of operation when the shutter button is pressed.

5. The digital camera of claim 4, wherein the image sensor is configured to generate at least one test digital image in the sub-sampling mode, and wherein the controller is configured to analyze the at least one test digital image and determine whether the exposure and white balance of the image are appropriate.

6. The digital camera of claim 5, wherein the controller is configured to adjust at least one setting of the image sensor if the exposure or white balance are not appropriate.

7. The digital camera of claim 5, wherein the controller is configured to cause the image sensor to enter the normal mode of operation if the exposure and white balance are appropriate.

8. The digital camera of claim 1, wherein the image sensor is a CMOS image sensor.

9. The digital camera of claim 1, wherein the sub-sampling mode is a two-to-one sub-sampling mode.

10. The digital camera of claim 1, wherein the sub-sampling mode is a four-to-one sub-sampling mode.

11. A method of automatically adjusting settings of an image sensor in a digital imaging system, the image sensor including a pixel array with a plurality of pixel circuits, the method comprising:
(a) generating a test frame based on outputs of a subset of the plurality of pixel circuits;
(b) analyzing the test frame to determine at least one image feature;
(c) modifying at least one image sensor parameter based on the at least one image feature of the test frame;
(d) repeating steps (a) through (c) until the at least one image feature meets a threshold value of goodness; and
(e) generating a full frame based on outputs of the plurality of pixel circuits using the at least one image sensor parameter.

12. The method of claim 11, and further comprising:
(f) analyzing the full frame to determine at least one image feature of the full frame;
(g) modifying at least one image sensor parameter based on the at least one image feature of the full image frame; and
(h) repeating steps (e) through (g) until the at least one image feature of the full frame meets a threshold value of goodness.

13. The method of claim 11, wherein the test frames are generated at a faster rate than the full frames.

14. The method of claim 11, wherein the test frames are generated using sub-sampling.

15. The method of claim 11, wherein the test frames are generated using windowing.

16. The method of claim 11, wherein the test frames are generated using a combination of sub-sampling and windowing.

17. The method of claim 11, wherein the at least one image feature includes exposure and white balance, and wherein the at least one image sensor parameter includes integration time and analog gain.

18. A digital camera comprising:
an image sensor configured to operate in a normal mode and a sub-sampling mode; and
a controller configured to cause the image sensor to enter the sub-sampling mode for generating sub-sampled images for auto functions, and cause the image sensor to enter the normal mode after completion of the auto functions.

19. The digital camera of claim 18, wherein the auto functions are selected from the group consisting of auto exposure, auto white balance, automatic flicker detection, and automatic black level.

20. The digital camera of claim 18, wherein the controller is configured to analyze the sub-sampled images to determine at least one image feature, and modify at least one image sensor setting based on the at least one image feature.
